(19) United States
(12) Patent Application Publication
(10) Pub. No.: US 2011/0070462 A1
(43) Pub. Date: Mar. 24, 2011

(54) PATTERN FORMING METHOD

(75) Inventors: Hiroshi Uchida, Oita-shi (JP); Masato Fukushima, Chiba-shi (JP); Yuko Sakata, Tokyo (JP)

(73) Assignee: Showa Denko K.K., Minato-ku (JP)

(21) Appl. No.: 12/992,493

(22) PCT Filed: May 14, 2009
(86) PCT No.: PCT/JP2009/059014

§ 371 Date: Nov. 12, 2010

(30) Foreign Application Priority Data
May 16, 2008 (JP) 2008-129700

(51) Int. Cl. B29C 35/08; G11B 5/62

(52) U.S. Cl. 428/800; 264/496

(57) ABSTRACT

Disclosed is a pattern forming method having a first step of forming a first ultraviolet curable resin layer on a substrate, a second step of leading a pattern-formed surface of a first mold wherein a predetermined pattern is formed to oppose the first ultraviolet curable resin layer, and attaching the substrate to the first mold by applying pressure, and a third step of irradiating diffused ultraviolet rays on the first ultraviolet curable resin layer, to which the pattern of the first mold is transferred by the pressure-attaching, the irradiated ultraviolet rays being diffused by disposing an ultraviolet light diffusion member between the ultraviolet curable resin layer and an ultraviolet light source.

### TECHNICAL FIELD

The present invention relates to a pattern forming method, a method for fabricating a discrete track magnetic recording medium using this pattern forming method, and a discrete track magnetic recording/reproducing apparatus equipped with a magnetic recording medium fabricated by this fabrication method. Priority is claimed on Japanese Patent Application No. 2008-129700, filed May 16, 2008, the content of which is incorporated herein by reference.

### BACKGROUND ART

In magnetic disk units, as the track density increases, for example, magnetic record information, between adjacent tracks interferes with each other, and as a result, the magnetic transition area in the boundary region becomes a noise source, thereby easily causing problems such as a deterioration of the signal-to-noise ratio (SNR).

In order to avoid such problems, attempts have been made to form recessed and protruding portions (a protruding portion may be referred to as a land or peak portion and a recessed portion as a groove or valley portion, for example) on the surface of the magnetic recording medium to physically separate recording tracks, thereby enabling an increase in the track density. Such a technique is called a discrete track method or a patterned media method due to the shape of recessed and protruding portions.

Nanoimprint lithography has been attracting attention as a technique for forming a more precise recessed and protruding structure using the aforementioned methods with improved throughput (see Patent Document 1, for example). Particularly, when a precise pattern is formed, it is said that among the various techniques of nanoimprint lithography, UV nanoimprinting using an ultraviolet curable resin in a layer of the side to which the pattern is transferred is effective (see Patent Document 2, for example).

By the way, ultraviolet rays irradiated from an ultraviolet light source often cause unevenness in the illuminance of ultraviolet rays depending on the irradiated portion. If such unevenness in the illuminance of ultraviolet ray occurs on a substrate (or a workpiece) having an ultraviolet curable resin layer while the UV nanoimprint method is used, problems such as uneven curing of ultraviolet curable resin on the substrate may occur, and mold releasing failure may also occur along with the uneven curing. Consequently, further problems might be caused such that the succeeding process of microfabrication which utilizes the precise pattern formed on the substrate may not be carried out evenly.

Especially, when a magnetic recording medium is processed utilizing the UV nanoimprint method, a defect in only a very small portion of the medium might cause the entire medium to be defective. Therefore, problems such as uneven curing occurred in the ultraviolet curable resin are serious.
Patent Document 1: Japanese Unexamined Patent Application, First Publication No. 2004-178793
Patent Document 2: Japanese Unexamined Patent Application, First Publication No. 2000-194142

### DISCLOSURE OF INVENTION

### Problems to be Solved

The present invention is proposed and intended to solve the above conventional problems and to provide a pattern forming method which prevents unevenness in the illuminance of ultraviolet rays irradiated onto a substrate and enables an ultraviolet curable resin on the substrate to be cured evenly.

The present invention also provides a method for fabricating a discrete track magnetic recording medium using this pattern forming method, and a discrete track magnetic recording/reproducing apparatus equipped with a magnetic recording medium fabricated by this fabrication method.

### Means to Solve the Problems

The present invention provides:

(1) a pattern forming method including: a first step of forming a first ultraviolet curable resin layer on a substrate; a second step of leading a pattern-formed surface of a first mold wherein a predetermined pattern is formed to oppose the first ultraviolet curable resin layer, and attaching the substrate to the first mold by applying a pressure; and a third step of irradiating diffused ultraviolet rays on the first ultraviolet curable resin layer, to which the pattern of the first mold is transferred by the pressure-attaching, the irradiated ultraviolet rays being diffused by disposing an ultraviolet light diffusion member between the ultraviolet curable resin layer and an ultraviolet light source;

(2) a pattern forming method as described in (1), wherein the third step is carried out simultaneously with the second step;

(3) a pattern forming method as described in (1), wherein the third step is carried out after the second step;

(4) a pattern forming method as described in any one of (1) to (3), further includes a step of preparing the first mold wherein the predetermined pattern is formed by forming a second ultraviolet curable resin layer on a resin sheet having a thickness in a range of 10 μm to 1 mm, and attaching a second mold having a pattern, wherein protruding portions and recessed portions are inverse to those of the predetermined pattern of the first mold, to the second ultraviolet curable resin layer in a manner in which the pattern having the inverse recessed and protruding portions comes into contact with the surface of the second ultraviolet curable resin layer, by applying a pressure to thereby transfer the pattern having the inverse recessed and protruding portions to the second ultraviolet curable resin layer;

(5) a pattern forming method as described in any one of (1) to (4), wherein the first mold has an ultraviolet ray transmittance of 20% or higher;

(6) a pattern forming method as described in any one of (1) to (5), wherein the first ultraviolet curable resin layer is formed by coating a liquid ultraviolet curable resin on the substrate;

(7) a pattern forming method as described in any one of (4) to (6), wherein the second ultraviolet curable resin layer is formed by coating a liquid ultraviolet curable resin on the resin sheet;

(8) a pattern forming method as described in any one of (1) to (7), wherein a diffusion plate or a fly eye lens is used as the ultraviolet light diffusion member;

(9) a pattern forming method as described in any one of (1) to (8), wherein the substrate is a magnetic recording medium;

(10) a method for fabricating a discrete track magnetic recording medium using a pattern forming method as described in any one of (1) to (9); and

(11) a magnetic recording/reproducing apparatus equipped with a discrete track magnetic recording medium fabricated by a method as described in (10).

The above-stated (2) to (9) are not essential factors, but illustrate preferable examples of the present invention.

### EFFECTS OF INVENTION

According to the present invention, a pattern forming method which prevents unevenness in the illuminance of ultraviolet ray irradiated on a substrate and enables an ultraviolet curable resin on the substrate to be cured evenly can be provided.

According to the present invention, further proposed is a method for fabricating a discrete track magnetic recording medium using this pattern forming method, and a discrete track magnetic recording/reproducing apparatus equipped with a magnetic recording medium fabricated by this fabrication method.

### BRIEF DESCRIPTION OF THE DRAWINGS

FIG. 1 is a sectional view showing a magnetic recording medium which is used as a substrate in an embodiment of a fabrication process of the magnetic recording medium having a pattern film formed by UV nanoimprinting using a pattern forming method of the present invention.

FIG. 2 is a sectional view showing a state in which a first ultraviolet curable resin layer is formed on the magnetic recording medium (a first step) in an embodiment of fabrication process of the magnetic recording medium having a pattern film formed by UV nanoimprinting using the pattern forming method of the present invention.

FIG. 3 is a sectional view showing a state in which a first mold is attached to the first ultraviolet curable resin layer by applying a pressure (a second step) in an embodiment of a fabrication process of the magnetic recording medium having a pattern film formed by UV nanoimprinting using the pattern forming method of the present invention.

FIG. 4 is a sectional view showing an example of stage variation in an embodiment of a fabrication process of the magnetic recording medium having a pattern film formed by UV nanoimprinting using the pattern forming method of the present invention.

FIG. 5 is a sectional view showing another example of stage variation in an embodiment of a fabrication process of the magnetic recording medium having a pattern film formed by UV nanoimprinting using the pattern forming method of the present invention.

FIG. 6 is a sectional view showing another example of stage variation in an embodiment of a fabrication process of the magnetic recording medium having a pattern film formed by UV nanoimprinting using the pattern forming method of the present invention.

FIG. 7 is a sectional view showing a variation of the second step in an embodiment of a fabrication process of the magnetic recording medium having a pattern film formed by UV nanoimprinting using the pattern forming method of the present invention.

FIG. 8 is a sectional view showing another variation of the second step in an embodiment of fabrication process of the magnetic recording medium having a pattern film formed by UV nanoimprinting using the pattern forming method of the present invention.

FIG. 9 is a sectional view showing another variation of the second step in an embodiment of fabrication process of the magnetic recording medium having a pattern film formed by UV nanoimprinting using the pattern forming method of the present invention.

FIG. 10 is a sectional view showing another variation of the second step in an embodiment of fabrication process of the magnetic recording medium having a pattern film formed by UV nanoimprinting using the pattern forming method of the present invention.

FIG. 11 is a sectional view showing a state in which the first ultraviolet curable resin layer is cured by irradiating ultraviolet rays via a light diffusion member (a third step) in an embodiment of a fabrication process of the magnetic recording medium having a pattern film formed by UV nanoimprinting using the pattern forming method of the present invention.

FIG. 12 is a sectional view showing a process of measuring illuminance of ultraviolet rays in an embodiment of a fabrication process of the magnetic recording medium having a pattern film formed by UV nanoimprinting using the pattern forming method of the present invention.

FIG. 13 is a sectional view showing the magnetic recording medium having a pattern film obtained in an embodiment of a fabrication process of the magnetic recording medium having a pattern film formed by UV nanoimprinting using the pattern forming method of the present invention.

FIG. 14 is a sectional view showing another example in which a pattern film is formed only on one side of the magnetic recording medium in an embodiment of a fabrication process of the magnetic recording medium having a pattern film formed by UV nanoimprinting using the pattern forming method of the present invention.

FIG. 15 is a sectional view showing irradiation variation in the third step in an embodiment of a fabrication process of the magnetic recording medium having a pattern film formed by UV nanoimprinting using the pattern forming method of the present invention.

FIG. 16 is a sectional view showing another irradiation variation in the third step in an embodiment of a fabrication process of the magnetic recording medium having a pattern film formed by UV nanoimprinting using the pattern forming method of the present invention.

FIG. 17 is a sectional view showing another irradiation variation in the third step in an embodiment of a fabrication process of the magnetic recording medium having a pattern film formed by UV nanoimprinting using the pattern forming method of the present invention.

FIG. 18 is a sectional view showing an example in which the second and third steps are carried out simultaneously in an embodiment of a fabrication process of the magnetic recording medium having a pattern film formed by UV nanoimprinting using the pattern forming method of the present invention.

FIG. 19 is a sectional view showing another example in which the second and third steps are carried out simultaneously in an embodiment of a fabrication process of the magnetic recording medium having a pattern film formed by UV nanoimprinting using the pattern forming method of the present invention.

FIG. 20 is a sectional view showing a part of a fabrication process of a discrete track magnetic recording medium to which the present invention is applied.

FIG. 21 is a sectional view showing another part of a fabrication process of the discrete track magnetic recording medium to which the present invention is applied.

FIG. 22 is a sectional view showing another part of a fabrication process of the discrete track magnetic recording medium to which the present invention is applied.

FIG. 23 is a sectional view showing another part of a fabrication process of the discrete track magnetic recording medium to which the present invention is applied.

FIG. 24 is a perspective view showing an example of a discrete track magnetic recording/reproducing apparatus to which the present invention is applied.

FIG. 25 is a perspective view showing a head gimbal assembly provided in the magnetic recording/reproducing apparatus shown in FIG. 24.

FIG. 26 is a perspective view showing a lamination film prepared in the fabrication process of the discrete track magnetic recording medium in Examples.

FIG. 27A is a perspective view showing a mother stamper used in the fabrication process of the discrete track magnetic recording medium in Examples.

FIG. 27B is a partial enlarged view showing a pattern of the mother stamper.

FIG. 28 is a sectional view showing a pressing step for obtaining a replica mold, which is a part of the fabrication process of the discrete track magnetic recording medium in Examples.

FIG. 29 is a sectional view showing an ultraviolet rays irradiation step for obtaining the replica mold in the fabrication process of the discrete track magnetic recording medium in Examples.

FIG. 30 is a sectional view of the replica mold in the fabrication process of the discrete track magnetic recording medium in Examples.

FIG. 31 is a sectional view showing a state in which the replica mold is attached to the ultraviolet curable resin layer by applying a pressure in the fabrication process of the discrete track magnetic recording medium in Examples.

FIG. 32 is a sectional view showing a state in which the ultraviolet curable resin layer is cured by irradiating ultraviolet rays via a light diffusion member in the fabrication process of the discrete track magnetic recording medium in Examples.

### DESCRIPTION OF THE REFERENCE NUMERALS

1: magnetic recording medium
2: non-magnetic substrate
3: magnetic layer
4: protective layer
5: ultraviolet curable resin layer
5a: pattern film
6: workpiece
7: first mold
7A: pattern
8: stage
8a: ultraviolet light diffusion stage
9: grabbing jig
10: guide pin
11: chucking slot
12: weight
12a: ultraviolet light diffusion weight
13: groove
14: guide rail
15: presser plate
15a: ultraviolet light diffusion presser plate
16: roller
17: ultraviolet light source
18: ultraviolet light diffusion member
19: sensor portion of ultraviolet illuminance meter
20: light guide
21: non-magnetic substrate
22: magnetic layer
23: protective layer
24: pattern film
25: magnetic recording medium
26: non-magnetic material
27: protective layer
28: discrete track magnetic recording medium
29: medium driving unit
30: head gimbal assembly
31: magnetic head
32: head driving unit
33: recording/reproducing signal system (recording/reproducing signals processing means)
41: suspension arm
42: head slider
43: signal line
50: film
51: ultraviolet curable resin layer
52: lamination film
53: circular plate
54: pattern
55: mother stamper
56: synthetic quartz plate
57: stainless plate
58: diffusion plate
59: ultraviolet irradiation device
60: pattern portion
61: replica mold
62: magnetic recording medium
63: coating film
64: synthetic quartz plate
65: diffusion plate
66: ultraviolet irradiation device

### BEST MODE FOR CARRYING OUT THE INVENTION

The present invention relates to a pattern forming method to form a predetermined pattern on an ultraviolet curable resin using imprint technique, a method for fabricating a discrete track magnetic recording medium using this pattern forming method, and a discrete track magnetic recording/reproducing apparatus equipped with a magnetic recording medium fabricated by this fabrication method. A pattern forming method, a method for fabricating a discrete track magnetic recording medium, and a discrete track magnetic recording/reproducing apparatus to which the present invention is applied will be described below in detail with reference to the drawings. In the drawings used in the following description, featuring parts might be enlarged, for convenience, in order to make such features comprehensible, and the aspect ratio, etc. of each component might be different from the actual one. Moreover, the present invention is not limited to these embodiments, and addition, omission, substitution of the structure and various other changes and modifications (e.g. number, position, size and the like) may be made without departing from the spirit of the invention.

### (Pattern Forming Method)

First of all, an embodiment of a pattern forming method to which the present invention is applied will be described.

UV nanoimprint technique using the pattern forming method of the present invention can be applied, for example, to fabrication of a magnetic recording medium having a pattern film.

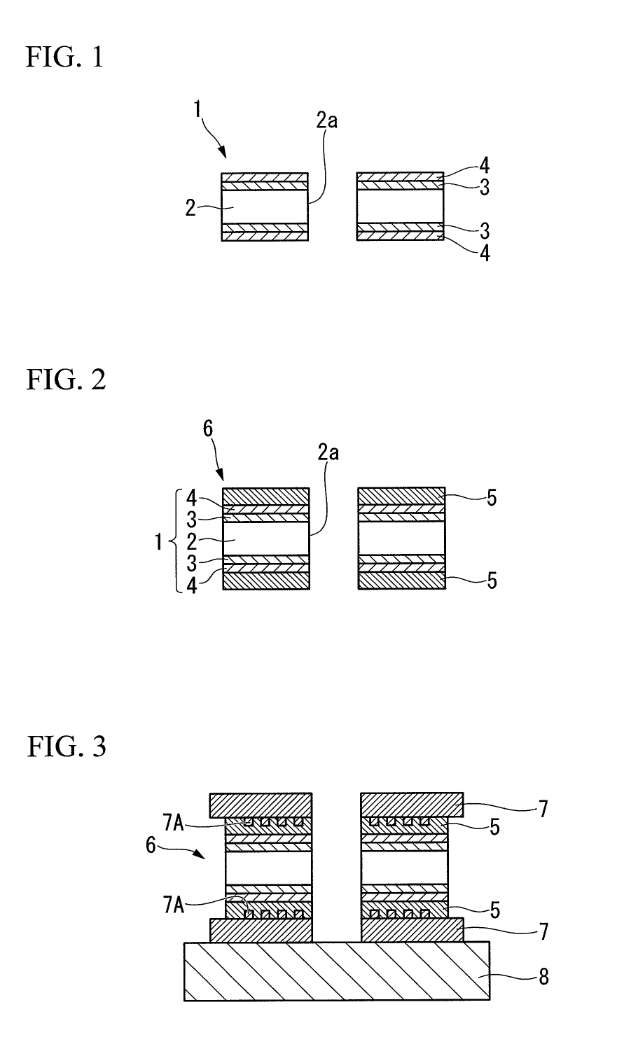

Concretely, in order to apply the present invention to the fabrication of a magnetic recording medium having a pattern film, first of all, a magnetic recording medium 1 is prepared as a substrate as shown in FIG. 1. The magnetic recording medium 1 used here is not limited in particular and suitable ones can be selected based on necessity. A non-magnetic substrate 2 having a central bore 2a at the center and having magnetic layers 3 and/or protective layers 4 formed on both sides thereof can be given as an example. The number and types of the magnetic layer 3 can be selected based on necessity. The magnetic layer 3 may be an in-plane magnetic recording layer or a perpendicular magnetic recording layer. The protective layer can also be selected according to necessity. The magnetic recording medium 1 is not limited to the non-magnetic substrate 2 having the magnetic layers 3 and the protective layers 4 formed on both sides thereof, and a non-magnetic substrate 2 having the magnetic layer 3 and the protective layer 4 formed on only one side thereof may also be used. While the thickness of the non-magnetic substrate differs depending on the size of the magnetic recording medium (disc) and can be selected according to necessity, it is preferably in a range of 0.2 to 1.6 mm, and more preferably in a range of 0.2 to 1.4 mm.

For a magnetic recording layer used in an in-plane magnetic recording medium, a lamination structure including a basal layer of non-magnetic CrMo and a magnetic layer of ferromagnetic CoCrPtTa, for example, can be used. For the magnetic recording layer used in a perpendicular magnetic recording medium, a lamination including a backing layer made of a soft magnetic FeCo alloy (such as FeCoB, FeCoSiB, FeCoZr, FeCoZrB, FeCoZrBCu, and the like), an FeTa alloy (such as FeTaN, FeTaC, and the like), a Co alloy (such as CoTaZr, CoZrNB, CoB, and the like) or the like, an orientation controlling film made of such as Pt, Pd, NiCr, NiFeCr and the like, an interlayer film made of Ru etc. if necessary, and a magnetic layer made of, for example, a 70Co-15Cr-15Pt alloy, a 90(80Co-5Cr-15Pt)/10SiO₂ alloy, and the like can be used.

While the thickness of the magnetic recording layer may be selected according to necessity, it is generally in a range of 3 to 20 nm, and preferably in a range of 5 to 15 nm. The magnetic recording layer is required to be formed so as to obtain sufficient head input and output in accordance with the kind of magnetic alloys used and the lamination structure. The magnetic layer is required to have more than a certain film thickness in order to achieve a certain level of output when reproducing is performed. On the other hand, various parameters showing recording and reproducing properties are generally degraded with the elevation of output. Therefore, it is necessary to adjust the film thickness suitably. The magnetic recording layer is generally formed as a membrane by sputtering, and during this process, for example, a recessed and protruding structure is formed on the magnetic recording layer.

On a surface of the magnetic recording layer, a protective film layer is formed. For the protective film layer, a carbonaceous layer of such as carbon (C), hydrogenated carbon (H×C), nitride carbon (CN), amorphous carbon, silicon carbide (SiC), and the like, and other materials generally used for the protective film layer such as SiO₂, ZrO₂, Ti₃N₄ and the like can be used. Moreover, the protective film may be formed of two or more layers.

While the film thickness of the protective layer 3 is selected according to necessity, it is preferably less than 10 nm. When the film thickness exceeds 10 nm, the distance between the head and the magnetic layer gets wider, so that sufficient strength of input and output signals might not be obtained.

The protective film layer is generally formed by sputtering, and during this process, a protective film having recessed and protruding portions is formed following the aforementioned recessed and protruding structure. The protective film in the recessed portions tends to be thicker than that in the protruding portions.

Next, as shown in FIG. 2, first ultraviolet curable resin layers 5 are formed on the magnetic recording medium 1 to fabricate a workpiece 6 (referred to as a first step hereinafter). The ultraviolet curable resin 5 used here has no particular restriction and can be selected according to necessity. Examples of the suitable ultraviolet curable resins include resin compositions containing compounds having a curable group such as a (meth)acryloyl group, a vinyl ether group, an N-vinyl amide group, a vinyl ester group, a styryl group (an aromatic vinyl group), an oxetanyl group, a glycidyl group, and/or a cyclohexene oxide group. Among these, resin compositions containing compounds having a curable group with a high curing speed such as the (meth)acryloyl group, the oxetanyl group, and/or the cyclohexene oxide group are used preferably.

Examples of the compounds having the (meth)acryloyl group include monomers such as: aliphatic mono (meth)acrylate such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, hexyl (meth)acrylate, octyl (meth)acrylate, 2-ethylhexyl (meth)acrylate, decyl (meth)acrylate, isobornyl (meth)acrylate, cyclohexyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate and the like; aromatic mono (meth)acrylate such as phenyl (meth)acrylate, benzyl (meth)acrylate, 2-hydroxyphenyl ethyl (meth)acrylate and the like; (meth)acrylamide such as N,N-dimethyl (meth)acrylamide, N,N-diethyl (meth)acrylamide, N-acryloyl morpholine and the like; aliphatic polyfunctional (meth)acrylate such as ethylene glycol di(meth)acrylate, propylene glycol di(meth)acrylate, 1,4-butanediol di(meth)acrylate, diethylene glycol di(meth)acrylate, triethylene glycol di(meth)acrylate, trimethylolpropane di(meth)acrylate, trimethylolpropane tri(meth)acrylate, pentaerythritol penta (meth)acrylate and the like; aromatic polyfunctional (meth)acrylate such as ethylene oxide-modified bisphenol A (meth)acrylate, propylene oxide-modified bisphenol A (meth)acrylate and the like; and fluorine-containing (meth)acrylate such as 2-trifluoromethyl propenoic acid trifluoroethyl ester, 2-trifluoromethyl propenoic acid t-butyl ester, 2,2,2-trifluoroethyl (meth)acrylate, 2,2,3,3-tetrafluoropropyl (meth)acrylate, 1H,1H,5H-octafluoropenthyl (meth)acrylate, perfluorooctyl ethyl (meth)acrylate and the like. Examples further include generally-called epoxy (meth)acrylates, which are formed by adding (meth)acrylate to epoxy resins such as bisphenol A type epoxy resin, hydrogenated bisphenol A type epoxy resin, brominated bisphenol A type epoxy resin, bisphenol F type epoxy resin, novolak type epoxy resin, phenol novolak type epoxy resin, cresol novolak type epoxy resin, alicyclic epoxy resin, N-glycidyl type epoxy resin, bisphenol A novolak (type) epoxy resin, chelate type epoxy resin, glyoxal type epoxy resin, amino group containing epoxy resin, rubber-modified epoxy resin, dicyclopentadiene phenolic type epoxy resin, silicone-modified epoxy resin, epsilon-caprolactone modified epoxy resin, and the like, and various types of urethane (meth)acrylates are also included.

Examples of compounds having a vinyl ether group include: aliphatic monovinyl ethers such as 2-ethylhexyl vinyl ether, octadecyl vinyl ether, 4-hydroxybutyl vinyl ether, diethylene glycol monovinyl ether, triethylene glycol monovinyl ether, 9-hydroxynonyl vinyl ether, methoxyethyl vinyl ether, ethoxyethyl vinyl ether and the like; alicyclic monovinyl ethers such as cyclohexyl vinyl ether, 4-hydroxycyclohexyl vinyl ether, cyclohexanedimethanol monovinyl ether, tricyclodecanyl vinyl ether and the like; aliphatic divinyl ethers such as 1,4-butanediol divinyl ether, nonanediol divinyl ether, triethylene glycol divinyl ether and the like; alicyclic divinyl ethers such as cyclohexanediol divinyl ether, cyclohexanedimethanol divinyl ether, tricyclodecan dimethanol divinyl ether, pentacyclo pentadecan dimethanol divinyl ether and the like; and polyfunctional vinyl ethers such as trimethylolpropane trivinyl ether, pentaerythritol tetravinyl ether and the like.

Examples of the compounds having an N-vinyl amide group include N-vinyl formaldehyde, N-vinylpyrrolidone and the like.

Examples of the compounds having a cyclohexene oxide group include cyclohexene oxide and its derivatives such as 3′,4′-epoxycyclohexane carboxylate 3,4-epoxycyclohexylmethyl, limonene dioxide, vinyl cyclohexene oxide, bis-(3,4-epoxycyclohexylmethyl adipate), epoxidated butane tetracarboxylate tetrakis-(3-cyclohexenylmethyl) modified epsilon-caprolactone, 1,2-epoxy-4-(2-oxylanyl)cyclohexane adduct of 2,2-bis(hydroxymethyl)-1-butanol, 3,4-epoxycyclohexane-1-carboxylic acid allyl ester, 3,4-epoxycyclohexane-1-methyl-1-carboxylic acid allyl ester and the like. Examples of the compounds having a glycidyl group include epoxy resin such as bisphenol A type epoxy resin, hydrogenated bisphenol A type epoxy resin, brominated bisphenol A type epoxy resin, bisphenol F type epoxy resin, novolak type epoxy resin, phenol novolak type epoxy resin, cresol novolak type epoxy resin, alicyclic epoxy resin, N-glycidyl type epoxy resin, bisphenol A novolak type epoxy resin, chelate type epoxy resin, glyoxal type epoxy resin, amino group containing epoxy resin, rubber-modified epoxy resin, dicyclopentadiene phenolic type epoxy resin, silicone-modified epoxy resin, epsilon-caprolactone modified epoxy resin and the like. Examples of compounds having an oxetanyl group include oxethane resin such as ARON OXETANE series (trade name) manufactured by Toagosei Co., Ltd., ETERNACOLL OXETAN series (trade name) manufactured by Ube Industries, Ltd. and the like.

Besides those mentioned above, commercially available UV curable resins for nanoimprinting such as PAK-01 (product of Toyo Gosei Co., Ltd.), NIF-A-1 (product of Asahi Glass Co., Ltd.) and the like may be used. These ultraviolet curable resins may be used alone or in combination of two or more kinds. Further, when these ultraviolet curable resins are applied on substrates, one or more materials such as a surface conditioner, a viscosity control agent, a solvent and the like, for example, besides a photopolymerization initiator and a sensitizer may be added according to necessity.

Furthermore, it is desirable that the viscosity of the ultraviolet curable resin 5 at room temperature after the solvent is dried is not more than 10000 mPa·s from the viewpoint of a pattern transfer property described later. The thickness of the ultraviolet curable resin layer is preferably in a range of 30 to 300 nm, and more preferably in a range of 50 to 200 nm.

The method for forming the ultraviolet curable resin layer 5 is not particularly limited. For example, methods such as spin coating, dip coating, spray coating, ink jet printing and the like may be used and may be selected suitably according to the conditions such as viscosity of the ultraviolet curable resin 5 to be used.

Next, one or more first molds 7 having a pattern-formed surface are prepared. The number and/or shapes of the mold may be selected according to necessity. On the pattern-formed surface, a pattern 7A has been formed which has protruding portions that correspond to non-magnetic portions of the discrete track magnetic recording medium described later and recessed portions that correspond to magnetic portions thereof. As shown in FIG. 3, on both sides of the workpiece 6, the first molds 7 are disposed above and below the workpiece 6 so that the patterns 7A oppose the first ultraviolet curable resin layers 5. Then, the workpiece 6 and the first molds 7 are placed and held on the top of a stage 8 and the workpiece 6 and the first molds 7 are attached by applying a pressure (referred to as a second step hereinafter). An attaching method and/or conditions may be selected according to necessity.

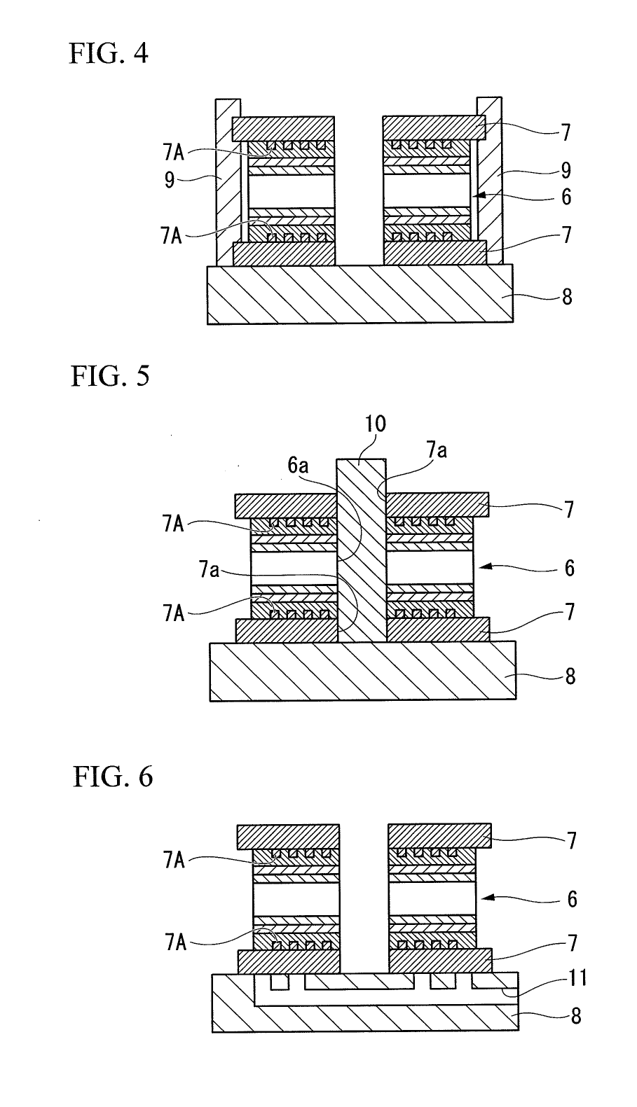

Materials and shapes of the stage 8 are not particularly limited as long as the stage can maintain the workpiece 6 and the first molds 7 stably. For example, the stage 8 may be a stage having grabbing jig 9 so as to chuck the molds 7 as shown in FIG. 4, a stage on which the workpiece 6 and the first molds 7 are fixed by a guide pin 10 which is put through central bores 6a and 7a provided on the workpiece 6 and the first mold 7 respectively as shown in FIG. 5, and/or a stage on which a chucking slot 11 is provided for vacuum chucking the workpiece 6 to the stage 8 as shown in FIG. 6.

For the first mold 7, it is desirable to use materials which transmit 20% or more of the ultraviolet rays irradiated upon the UV nanoimprinting. For example, molds formed by materials such as quartz, glass, cyclo-olefin polymer (e.g., trade name: ZEONOR, manufactured by Zeon Corporation), cyclo-olefin copolymer (e.g., trade name: APL, manufactured by Mitsui Chemicals Inc.; and trade name: TOPAS, manufactured by Polyplastics Co., Ltd.), polyethylene terephthalate, poly(4-methyl-pentene-1), polycarbonate and the like may be used. Moreover, these materials may be used alone or in combination of two or more by mixing or by laminating two or more layers in order to form the mold. The thickness of the first mold 7 is preferably in a range of 10 to 1000 μm, and more preferably in a range of 25 to 500 μm.

The first mold 7 can also be obtained by forming a second ultraviolet curable resin layer on a resin sheet, followed by forming the aforementioned pattern 7A on a surface of this second ultraviolet curable resin layer. For example, by attaching a second mold having a pattern inverse to the pattern 7A to the second ultraviolet curable resin layer by applying pressure in a manner in which the inverse pattern comes into contact with the surface of the second ultraviolet curable resin layer, the transferred pattern of this pattern may be used as the pattern 7A. Here, the inverse pattern signifies that the protruding and recessed parts are formed inverse. Therefore, the inverse pattern corresponds to the configuration of the pattern 7A, that is, the two patterns have the same configuration, and when the inverse pattern and the pattern 7A are laminated, the two patterns fit each other perfectly just as a casting and a mold. While the mold pattern may be selected according to necessity, to give a single example, the width of the protruding and/or recessed portions of the pattern is preferably in a range of 20 to 200 nm, and more preferably in a range of 30 to 150 nm. The difference of height between the protruding portion and the recessed portion is preferably in a range of 40 to 150 nm, and more preferably in a range of 60 to 100 nm.

As a concrete example, the second ultraviolet curable resin is applied on a resin sheet made of a material such as cyclo-olefin polymer, cyclo-olefin copolymer, polyethylene terephthalate, poly(4-methyl-pentene-1), polycarbonate and the like, and then a mother stamper (the second mold) is attached thereto by applying a pressure using UV nanoimprinting, and the pattern transferred thereby on the resin is used preferably as the first mold 7, since external waviness on the surface of the workpiece 6 can be easily followed and a high accuracy of mold pattern can be achieved according to this method. The pattern of the mother stamper has a pattern in which the protruding and recessed portions are inverse to those in the pattern 7A of the first mold 7.

While the thickness of the resin sheet may be selected based on necessity, from the viewpoint of handling property and following easiness with respect to the surface of the workpiece 6, it is preferably in a range of from 10 μm to 1 mm. While the thickness of the second ultraviolet curable resin may also be selected based on necessity, it is preferably in a range of from 1 μm to 100 μm from the viewpoint of accuracy and the like upon transferring the pattern of the mother stamper.

For the second ultraviolet curable resin, the same materials as those listed for the first ultraviolet curable resin 5 may be used. Further, in case that the resin sheet is stored for a long term after being coated by the second ultraviolet curable resin, it is preferable for the second ultraviolet curable resin that the second ultraviolet curable resin contains 50% by mass or more of, and preferably 70% to 100% by mass of solid resin or resin which has viscosity of 100000 mPa·s or more and preferably 500000 mPa·s or more at room temperature. Furthermore, in case great importance is attached particularly to the precision of the pattern of the prepared resin-made replica mold, it is desirable to use liquid resins having a viscosity of 50000 mPa·s or less, and preferably in a range of 3000 to 30000 mPa·s at room temperature. The viscosity of liquid resins may be measured using, for example, a rotational viscometer.

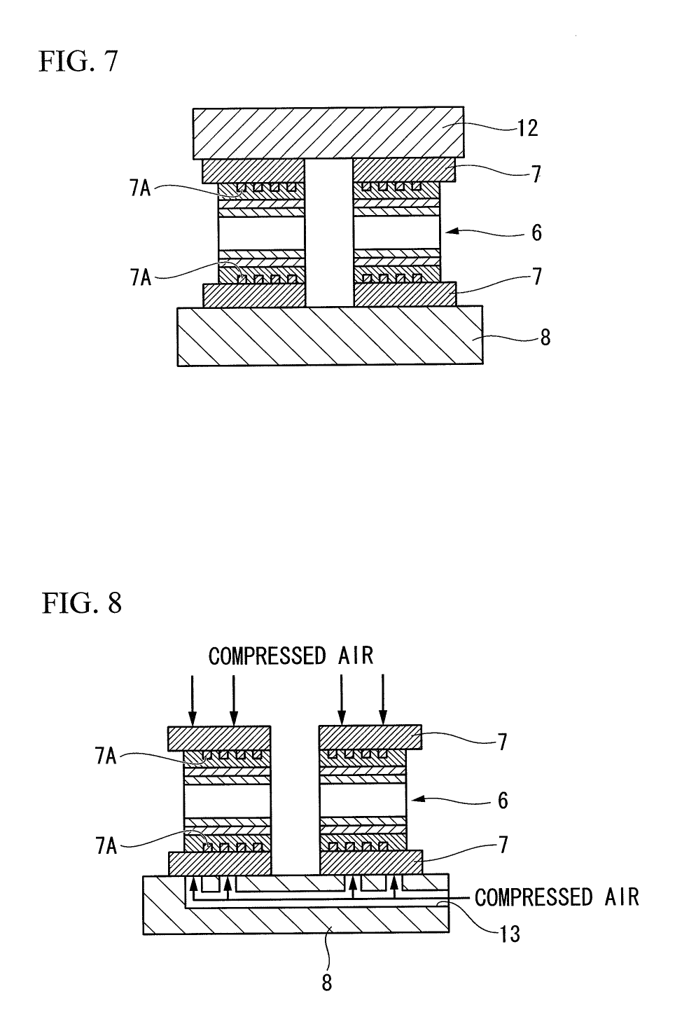

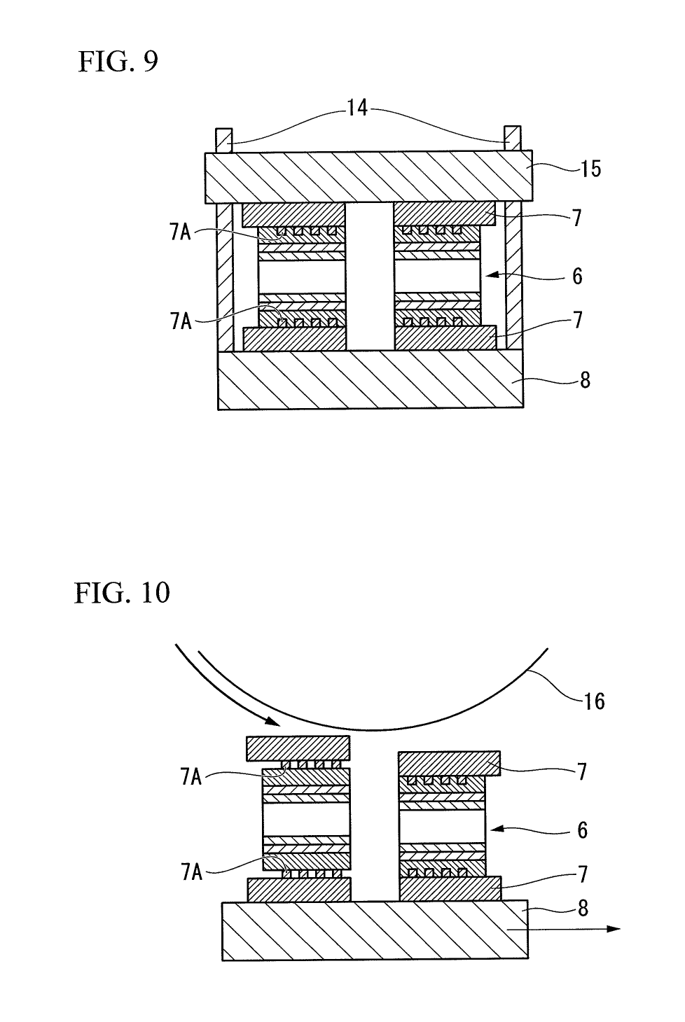

Members for attaching the workpiece 6 and the first mold 7 by pressure are not particularly limited. For example, a manner to hold them by hands, a manner to put a weight 12 on them as shown in FIG. 7, a manner to attach them by compressed air due to inject compressed air by providing a slot 13 in the stage 8 as shown in FIG. 8, a manner to press them by a press device provided with a presser plate 15 which can slide vertically along guide rails 14 as shown in FIG. 9, a manner to press them by a roller 16 as shown in FIG. 10 or the like may be adopted.

Here, the intensity of pressure for pressing down the first mold 7 to the workpiece 6 differs depending on the conditions such as the material and shape of the first mold 7, the material and shape of a substrate of the workpiece 6, the kind of the first ultraviolet curable resin 5 and the like. The pressure is preferably larger than 0 Pa and 50 Mpa or smaller. More preferably, the pressure is in a range of 0.001 to 3 Mpa. If pressure is not applied thereto at all, the surface of the workpiece 6 and the first mold 7 will not become parallel, so that there might be a portion where the first ultraviolet curable resin 5 and the first mold 7 do not come into contact with each other and/or the surface wherein the pattern 7A is formed might not become parallel with the substrate surface of the workpiece 6 but become oblique instead. On the other hand, when the pressure is too strong, the first mold 7 might be strained, and so the transfer accuracy might fall.

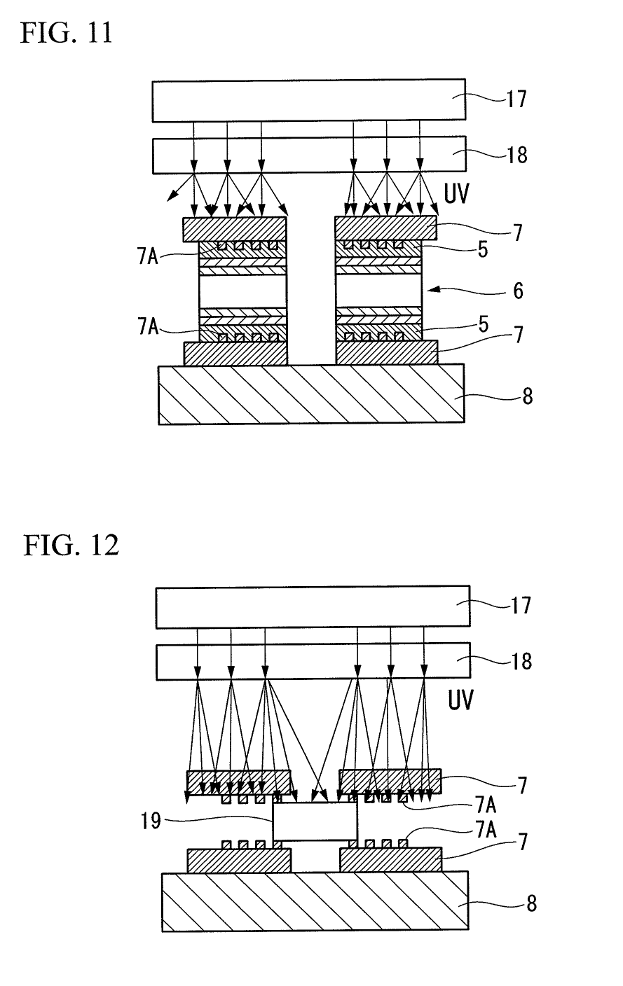

Next, an ultraviolet light source 17 irradiating ultraviolet (UV) rays on the stage 8 is disposed as shown in FIG. 11.

A light diffusion member 18 which diffuses ultraviolet rays (UV) is disposed between the ultraviolet light source 17 and the first workpiece 6. The ultraviolet rays (UV) diffused by the light diffusion member 18 are irradiated on the first ultraviolet curable resin layer 5 via the first mold 7 to thereby cure the first ultraviolet curable resin layer 5 which exists at the upper side. Following this, the workpiece 6 and the first mold 7 are turned upside down as they remain attached together due to pressure. In addition, in the same manner, the first ultraviolet curable resin layer 5 which is now in the upper side by being turned is cured by irradiation of the diffused ultraviolet rays. As described above, the pattern 7A of the first mold 7 is transferred to the first ultraviolet curable resin layer 5 (referred to as a third step hereinafter).

The light diffusion member 18 may be selected based on necessity. For example, commercially available diffusion plates, fly eye lenses and the like can be used. The diffusion plates are roughly divided into three types: i) a type in which micro irregularities are formed as a rugged micro structure on a surface of a plate or sheet made of quartz, glass, resin and the like to thereby diffuse the light; ii) a type in which, in a matrix which is a plate or a sheet similar to type (i), particles having a refractive index different from that of the matrix are dispersed to thereby diffuse the light; and iii) a type in which a coating film which can diffuse the light is formed on a surface of a plate or sheet similar to type (i) to thereby diffuse the light. However, any type of light diffusion members can be used. The thickness of the light diffusion member 18 is preferably in a range of from 0.5 to 5 mm, and more preferably in a range of from 1 to 3 mm. The size of the light diffusion member is preferably larger than the size of the workpiece. Another desirable property for the light diffusion member 18 is to have a high ultraviolet ray transmittance in all of a wavelength region of 250 nm to 400 nm. Since resin generally has low light transmittance of light with a wavelength of 350 nm or less, light transmittance of the light diffusion member 18 of light with a wavelength of 380 nm, for example, is preferably in a range of 10 to 95%, and more preferably in a range of 40 to 95%. Further, it is desirable that light transmittance of infrared light having a wavelength of 800 nm or longer, i.e. a heat ray, is low so as not to cause distortion of the workpiece 6 and/or the first mold 7 due to a temperature rise.

These light diffusion members 18 may be used singly or in combination of two or more. The first mold 7 may have a function to diffuse ultraviolet rays (UV). Examples of the first mold 7 capable of diffusing the ultraviolet ray (UV) include those molds having micro irregularities, a coating film capable of scattering light or the like being formed on a surface opposite to the pattern formed surface wherein the pattern 7A has been formed.

For the ultraviolet light source 17, any light source may be used with no particular limitation as long as it can cure the first ultraviolet curable resin layer 5. From the viewpoint of reducing the influence of the heat ray irradiated on the workpiece 6 along with the ultraviolet ray (UV), it is desirable to use an LED (light emitting diode) type light source or continuous/pulsed light emitting type light source. The former does not irradiate a heat ray concurrently with the ultraviolet ray (UV) and the latter irradiates the heat ray only intermittently. Thus, there is a characteristic that the workpiece 6 and the first mold 7 may not be distorted easily due to high temperature during the ultraviolet ray (UV) irradiation. While the illuminance may be selected according to necessity, it is preferably in a range of from about 50 to 3000 mj/cm², and more preferably in a range of from 100 to 1000 mj/cm².

The shapes of the ultraviolet light source 17 can be selected according to necessity. Commercially available spot type light sources, lamp units and the like may be used. When an LED type light source is used, such an exclusive light source may be created to be used so that LED devices are disposed in accordance with the shape etc. of the workpiece 6. Furthermore, these ultraviolet light sources 17 may be used singly or in combination of two or more. Different types of light sources can also be combined to be used. However, it is desirable to dispose the light sources so that the illuminance of the ultraviolet rays (UV) the workpiece 6 receives may be as uniform as possible.

When the temperature of the ultraviolet light source 17 rises too much, the life thereof might be shortened remarkably, meaning it is not economical.

The illuminance of the ultraviolet rays (UV) the workpiece 6 receives can be measured as illustrated in FIG. 12, for example. At the position where the workpiece 6 is disposed upon UV nanoimprinting, a sensor portion of ultraviolet illuminance meter 19 is disposed instead of the workpiece 6. Then, the ultraviolet light source 17 is turned on, thereby enabling the sensor to measure the illuminance. The position of the ultraviolet illuminance meter may be changed according to necessity.

According to the present invention, the distance between the workpiece 6 and the ultraviolet light source 17, or that between the first mold 7 and the ultraviolet light source 17 is not particularly limited. However, it is desirable to leave a space of 1 mm or more so that the heat generated by the LED devices and/or peripheral wirings might not be conducted. If the heat is conducted to the first mold 7 and/or the workpiece 6, the pattern 7A might be distorted, and consequently the pattern might not be transferred with high precision.

While the distance from the ultraviolet light source 17 to the light diffusion member 18 may also be selected based on necessity, it is preferably in a range of from 5 to 300 mm, and more preferably in a range of from 10 to 100 mm. Further, while the distance from the light diffusion member 18 to the first ultraviolet curable resin layer 5 may also be selected based on necessity, in case the light diffusion member 18 is provided separately, it is preferably in a range of from 100 to 500 mm, and more preferably in a range of from 100 to 300 mm.

According to the present invention, there is no particular limitation to the atmosphere within which the ultraviolet ray irradiation is carried out. However, in case where the ultraviolet curable resin 5 coated on the magnetic recording medium 1 is radically curable, it is desirable to replace the atmosphere by an inert gas such as nitrogen. On the other hand, in the case that the ultraviolet curable resin 5 is of cation curable, it is desirable to perform replacement of atmosphere using dry air and the like. In these cases, the cure rate can increase. Further, carrying out the ultraviolet ray irradiation under a vacuum atmosphere (or a decompression atmosphere) has effects of preventing generation of void, and is also effective in increasing the cure rate.

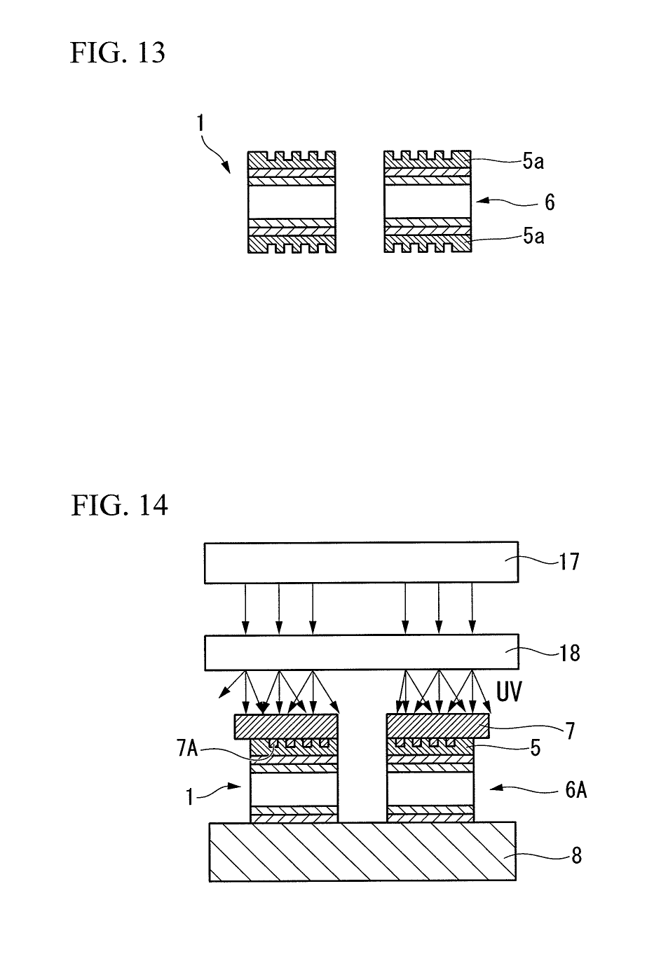

Next, as shown in FIG. 13, the mold 7 is separated from the workpiece 6 to thereby obtain a magnetic recording medium 1 having a pattern film 5a thereon. In this embodiment, when the pattern film 5a becomes a part of a fabricated discrete track magnetic recording medium, the part corresponding to a non-magnetic portion is recessed and the part corresponding to a magnetic portion protrudes from the pattern film 5a.

As described above, by using the pattern forming method according to the present invention, a pattern film 5a having uniform tolerance to various kinds of processes in any part and having few defects such as deformation of a pattern due to the difference in curing shrinkage ratios and/or mold releasing failure can be fabricated on the magnetic recording medium 1. Consequently, a magnetic recording medium with a pattern film having excellent yield rate and processing precision can be fabricated.

The pattern forming method according to the present invention is not necessarily limited to the foregoing embodiments. Various changes and modifications may be made without departing from the spirit of the invention.

For example, in the above-described embodiments, one workpiece 6 prepared by forming the first ultraviolet curable resin layers 5 on both faces of the magnetic recording medium 1 is disposed on the stage 8 along with two first molds 7 sandwiching the workpiece 6 as shown in FIG. 3. Further, as shown in FIG. 11, after attaching these first molds 7 to the workpiece 6 by applying a pressure, ultraviolet rays are irradiated from the ultraviolet light source 17. However, a UV nanoimprinting method according to the present invention is not limited thereto.

Another embodiment is illustrated in FIG. 14. In FIG. 14, a workpiece 6A, in which the first ultraviolet curable resin layer 5 is formed only on one side of the magnetic recording medium 1, is used. The first mold 7 may be disposed only on the side on which the first ultraviolet curable resin layer 5 is formed and the UV nanoimprinting may be carried out thereon. Accordingly, a magnetic recording medium 1 having a pattern film 5a formed only on one side thereof can be obtained. That is, the present invention is not limited to the magnetic recording medium 1 having the pattern films 5a formed on the both sides thereof, but can be applied to the magnetic recording medium 1 having the pattern film 5a formed only on one side.

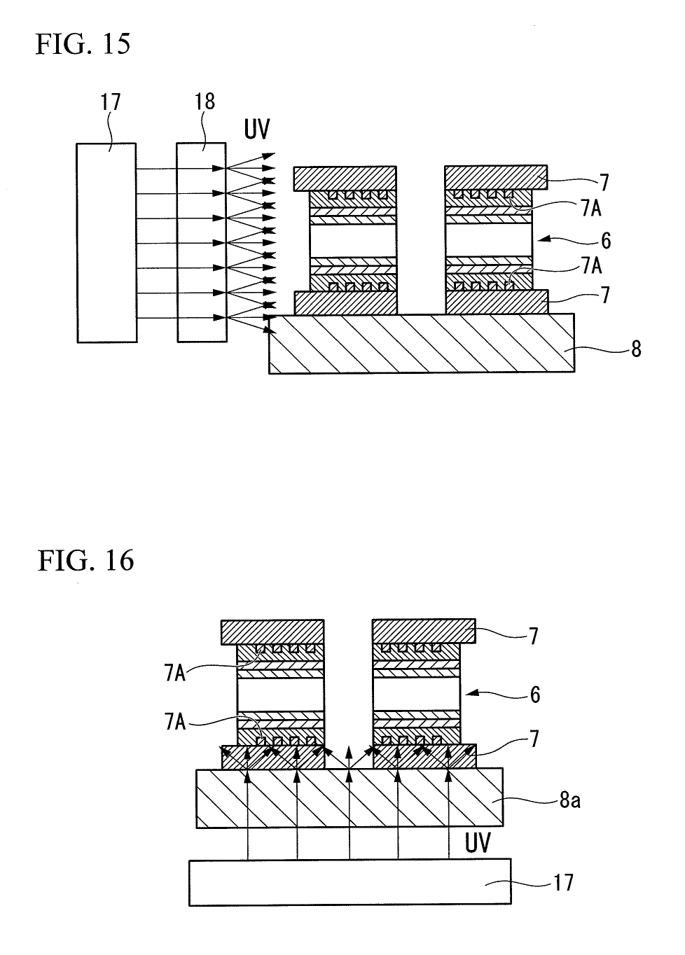

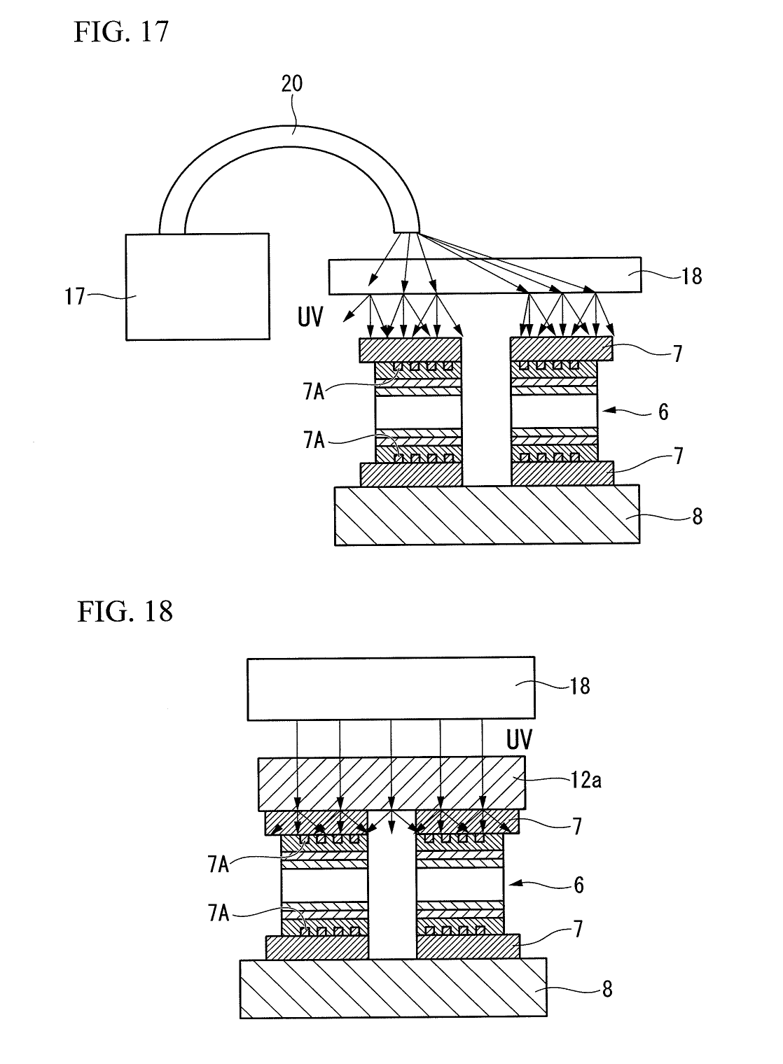

For the method for irradiating ultraviolet rays (UV), examples are illustrated in FIGS. 15 to 18. As illustrated in FIG. 15, the aforementioned ultraviolet light source 17 and the aforementioned light diffusion member 18 are disposed at the side of the workpiece 6 and the workpiece 6 may be irradiated by the diffused ultraviolet rays (UV) from a transverse direction. As illustrated in FIG. 16, by using a stage 8a which diffuses the ultraviolet rays (UV) and by carrying out the irradiation by the ultraviolet light source 17 disposed at the bottom side of the stage 8a, the workpiece 6 may also be irradiated by the diffused ultraviolet rays (UV) from the bottom side thereof. As illustrated in FIG. 17, by leading the ultraviolet rays (UV) emitted from the ultraviolet light source 17 to the light diffusion member 18 by the use of a light guide 20 and by disposing the light diffusion member 18 between the light guide 20 and the workpiece 6, the workpiece 6 may be irradiated with the diffused ultraviolet rays (UV). These methods may be used in combination.

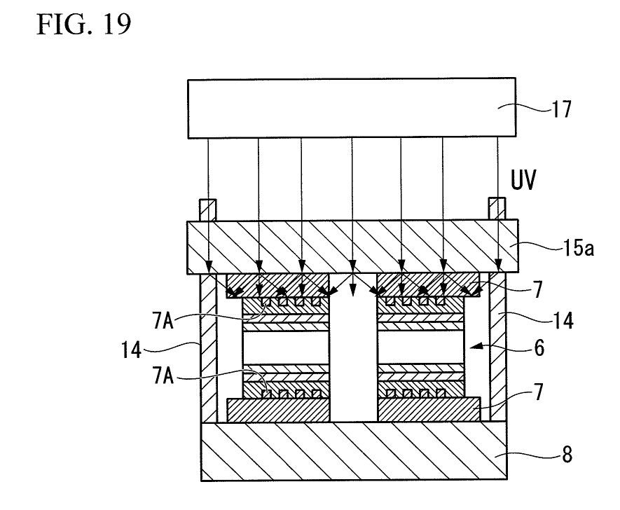

In the above-described embodiments, after the second step wherein the workpiece 6 and the first mold 7 are attached by the application of a pressure, the third step wherein the diffused ultraviolet rays (UV) are irradiated on the workpiece 6 is carried out. However, such a process in the third step may be carried out simultaneously with the second step. For example, as illustrated in FIG. 18, the diffused ultraviolet rays (UV) may be irradiated on the workpiece 6 in a manner in which a weight 12a made of, for example, quartz plate having micro irregularities on the surface and diffusing ultraviolet rays (UV) remains mounted on the first mold 7 and the workpiece 6. Further, as illustrated in FIG. 19, by using a press device provided with a presser plate 15a which can slide vertically along guide rails 14 and can diffuse the ultraviolet rays (UV), the ultraviolet rays (UV) diffused via the presser plate 15a may be irradiated on the workpiece 6.

### (Fabrication Method of Discrete Track Magnetic Recording Medium)

Next, an example of a procedure for fabricating a discrete track magnetic recording medium will be described.

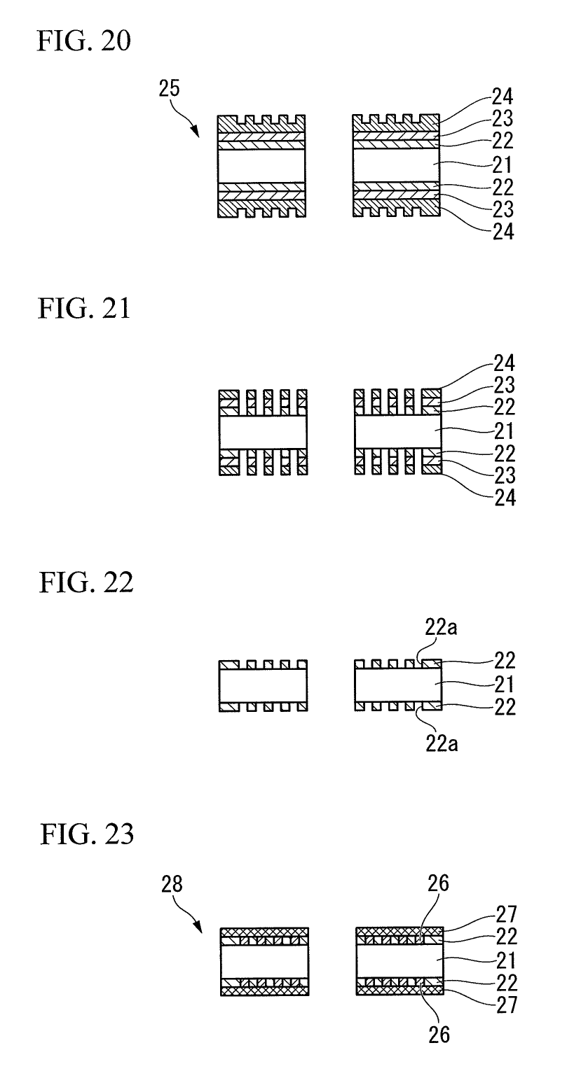

First of all, when a discrete track magnetic recording medium is fabricated, a magnetic recording medium 25 having pattern films 24, as shown in FIG. 20, is prepared. On this magnetic recording medium 25, which is structured with magnetic layers 22 and protective layers 23 being formed on a non-magnetic substrate 21, an ultraviolet curable resin is coated and UV nanoimprinting using the pattern forming method according to the present invention is carried out on this coated film to thereby transfer the predetermined pattern to the magnetic recording medium 25.

Next, as shown in FIG. 21, the protective layers 23 and the magnetic layers 22 are partially removed by techniques such as dry etching and the like with the pattern film 24 functioning as a mask.

Subsequently, the pattern film 24 and the protective layer 23 are peeled off as shown in FIG. 22 by techniques such as asking and the like.

Then, as shown in FIG. 23, recessed portions 22a formed on the magnetic layers 22 are buried with non-magnetic materials 26 to thereby flatten the whole surface, thus laminating a new protective layer 27 on the magnetic layer 22.

The discrete track magnetic recording medium 28 of the present invention can be obtained by following the above-described steps.

An example of a procedure for fabricating the discrete track magnetic recording medium of the present invention by carrying out the UV nanoimprinting using the pattern forming method according to the present invention has been described. However, the present invention is not necessarily limited to such a procedure.

For example, a magnetic recording medium 25 structured with magnetic layer(s) and protective layer(s) formed on a non-magnetic substrate is prepared. Mask layer(s) made of metal and the like is/are formed thereon, and an ultraviolet curable resin is coated further on the mask layer(s). Subsequently, a pattern film 24 made of an ultraviolet curable resin is formed by using the UV nanoimprinting method according to the present invention, and the pattern film 24 thus formed is used as a mask to thereby pattern the mask layer(s). Then, the patterned mask layer(s) may be used to pattern the magnetic layer(s) 22.

Still further, according to the present invention, methods other than partially removing the magnetic layer 22 can also be used in order to separate track areas mutually. For example, the pattern film 24 formed by the UV nanoimprinting method according to the present invention on the magnetic recording medium 25 is used as a mask, and on a part of the magnetic layer 22, atoms such as silicon, boron, fluorine, phosphor, tungsten, carbon, indium, germanium, bismuth, krypton, argon and the like may be injected by an ion beam method or the like as disclosed, for example, in Japanese Unexamined Patent Application, First Publication No. 2007-273067 so as to make an area where the magnetic part becomes amorphous to thereby separate track areas mutually.

### (Magnetic Recording/Reproducing Apparatus)

Next, a magnetic recording/reproducing apparatus (HDD) employing the present invention will be described.

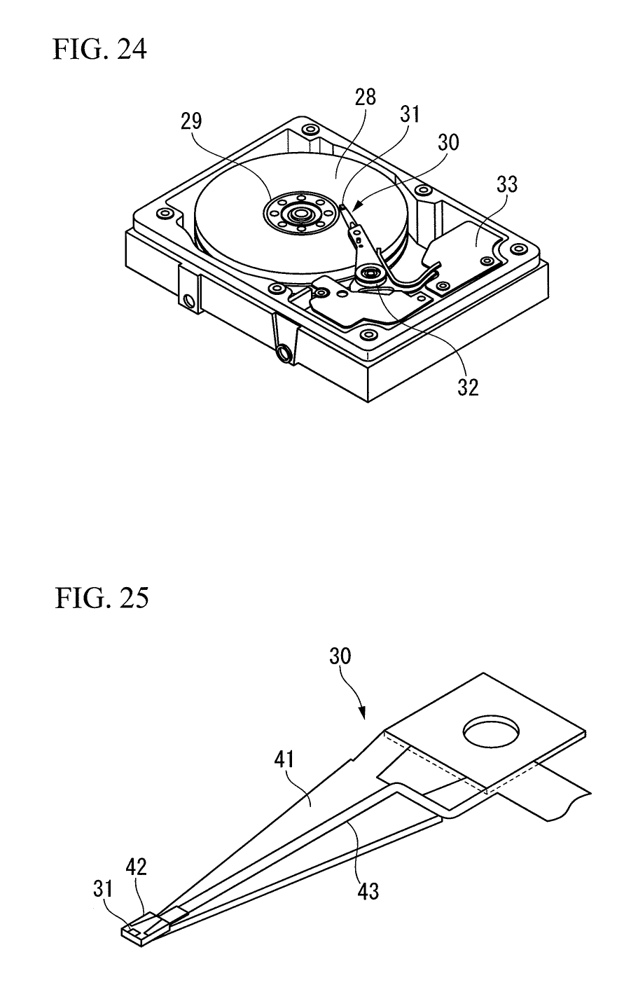

For example, the magnetic recording/reproducing apparatus employing the present invention as illustrated in FIG. 24 includes the above-described discrete magnetic recording medium 28 as shown in FIG. 23, a medium driving unit 29 which drives the recording medium 28 in a recording direction, a magnetic head 31 mounted to a head gimbal assembly 30, a head driving unit 32 which moves the magnetic head 31 relative to the discrete magnetic recording medium 28, and a recording/reproducing signal system 33 (a recording/reproducing signals processing means) for inputting signals to the magnetic head 31 and reproducing output signals from the magnetic head 31.

The head gimbal assembly 30 includes, as illustrated in FIG. 25, a suspension arm 41 formed of a metal sheet, a head slider 42 provided on the distal end side of the suspension arm 41, the aforementioned magnetic head 31 provided on the head slider 42, and a controlling member (not shown) conductively connected via a signal line 43.

The magnetic head 31 is disposed in the vicinity part of the discrete magnetic recording medium 28 which is in the trailing side of the head slider 42 opposite to the leading side thereof on which slopes are formed.

The magnetic head 31 is composed of a recording part and a reproducing part. The magnetic head 31 may be selected according to necessity. For example, not only heads having an MR (magnetoresistance) device and the like utilizing a giant magnetoresistive (GMR) effect, but also heads, suitable for high recording density, having a TMR (Tunnel-type Magneto Resistive) device and the like utilizing a tunnel-type magneto resistive (TMR) effect can be used as a reproducing device. By using the TMR device, recordings of still higher density may be possible.

Since the magnetic recording/reproducing apparatus structured as described above includes the discrete magnetic recording medium 28 to which the present invention is applied, the amount of levitation of the magnetic head 31 can be reduced, thereby enhancing stability and heightening recording density.

For example, when the magnetic head 31 is levitated at height of 0.005 μm to 0.020 μm which is lower than conventional levitation amount, the output thereof improves so as to obtain high SNR (signal to noise ratio), so that the magnetic recording device with mass volume and high reliability can be provided.

Moreover, the magnetic recording/reproducing apparatus includes the discrete magnetic recording medium 28 on which such a pattern is provided that is composed of protruding portions formed by a magnetic layer and recessed separative regions. Consequently, a respective track is not easily affected by adjacent tracks, so that without changing the width of operating field such that widening upon recording and narrowing upon reproduction, both of the recording and the reproducing can be operated in almost the same head width. Therefore, compared with the case in which the reproducing head width is made narrower than the recording head width, this magnetic recording/reproducing apparatus can obtain enhanced reproducing output and a high signal to noise ratio (SNR).

Furthermore, in the magnetic recording/reproducing apparatus of the present invention, by forming the reproducing part of the magnetic head 31 with a GMR head or a TMR head, a satisfactory signal intensity can be obtained even in high recording density, so that a magnetic recording/reproducing apparatus having a high recording density can be provided.

Still further, when signal processing circuits adopting maximum likelihood decoding algorithm is combined to the magnetic recording/reproducing apparatus of the present invention, the recording density can be improved still further, and a satisfactory SNR can be obtained even when recording and reproduction are operated at recording densities such as a track density of 100 K track/inch or more, a linear recording density of 1000 Kbit/inch or more, and an a real recording density of 100 Gbit/in² or more, for example.

### EXAMPLES

The effect of the present invention will be described with reference to the following examples. The present invention is not limited to the following examples, and can be practiced by making various changes and modifications properly without modifying the fundamentals of the invention.

### <Preparation of Resin-Made Replica Mold>

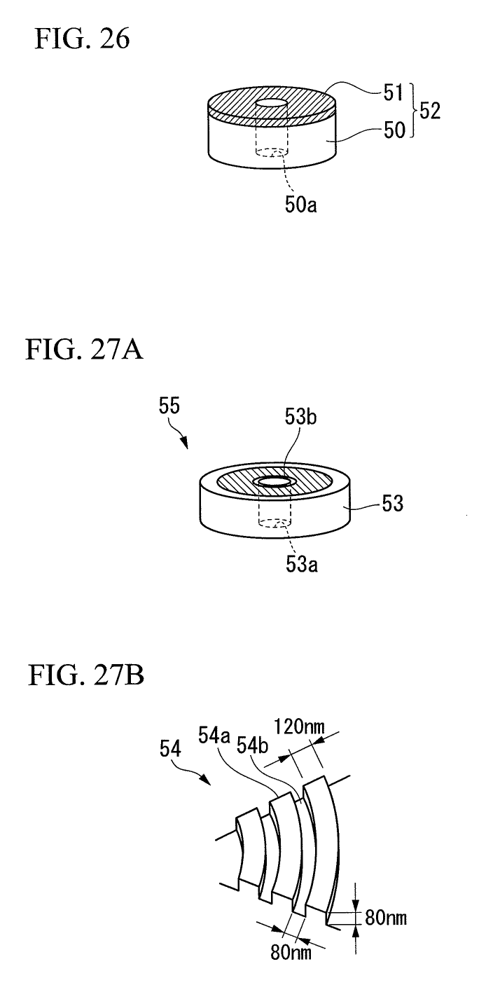

In an example, first of all, as illustrated in FIG. 26, on a highly adhesive surface of a disc-like film 50 which was fabricated by cutting out a polyethylene terephthalate film (a product of Toyobo Co., Ltd., trade name: COSMO SHINE A4100, 100 μm thick) and has a diameter of 70 mm and a central pore 50a with a diameter of 12 mm, a liquid resin used for UV nanoimprinting (product of Asahi Glass Co., Ltd., trade name: NIF-A-1) was coated by a bar coater to form an ultraviolet curable resin layer 51 of about 10 μm thickness, thus obtaining a lamination film 52.

Next, a circular plate 53 made of Ni having a diameter of 65 mm, a thickness of 0.3 mm, and a central pore 53a with a diameter of 12 mm was prepared, and a pattern 54 was formed on the circular plate 53 to thereby prepare a mother stamper 55 as shown in FIG. 27A. The pattern 54 is formed as a range 53b formed by two concentric circles whose outer diameter being 44 mm and inner diameter 18 mm on the surface of the circular plate 53. As shown in FIG. 27B, the pattern 54 is a concentric circular pattern having protruding portions 54a with a width of 120 nm, recessed portions 54b with a width of 80 nm, and a height difference of 80 nm between the recessed portion and the protruding portion.

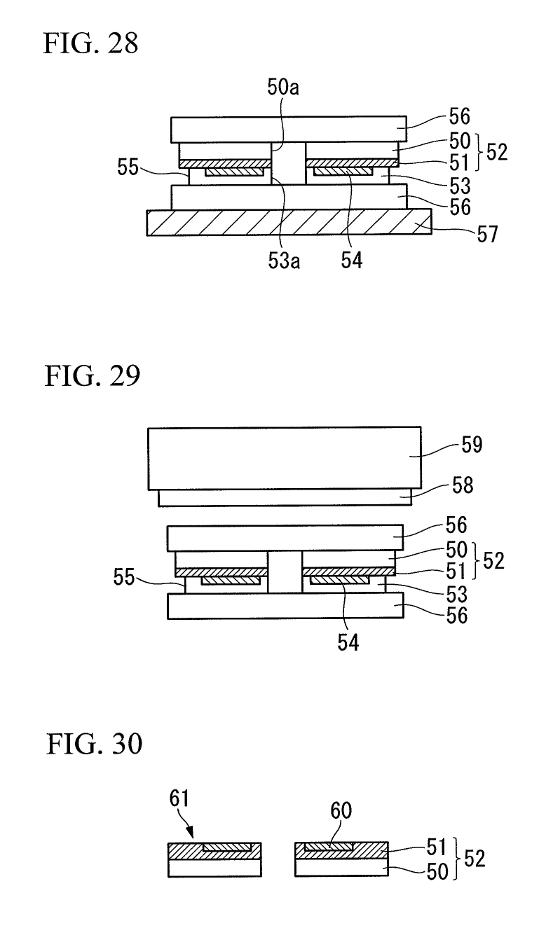

Then, as shown in FIG. 28, the mother stamper 55 and the lamination film 52 prepared previously were put to oppose each other in a state in which the surface of the mother stamper 55 on which the pattern 54 was formed faces upward, the ultraviolet curable resin layer 51 of the lamination film 52 faces downward and the two central pores 53a and 50a accord with each other. Further, all of these together were interposed between two synthetic quartz plates 56 (trade name: VIOSIL manufactured by Shin-etsu Chemical Co., Ltd.), and were then placed on a stainless plate 57 having a width and a depth of 80 mm and a thickness of 5 mm so as to be pressurized by self-weight of the synthetic quartz plate.

Subsequently, as shown in FIG. 29, the synthetic quartz plate 56, the lamination film 52, the mother stamper 55, and the synthetic quartz plate 56 were piled up from the top in this order and these were put, as they remain in piles, under a diffusion plate 58 (trade name: Quartz Sol-Gel LSD (UVSP) manufactured by Luminit, LLC (USA)), which had been mounted on the underside of an ultraviolet irradiation window of an ultraviolet irradiation device 59 (trade name: LED-Aicure manufacture by Matsushita Electric Works Co., Ltd.), to be irradiated by ultraviolet rays at an illuminance of 35 mW/cm² for 30 seconds.

The lamination film 52 was then peeled off from the mother stamper 55 to thereby obtain a replica mold 61 having a pattern portion 60 which has an inverse shape of the pattern 54 of the mother stamper 55 as shown in FIG. 30.

### <Preparation of Ultraviolet Curable Resin Solution to be Coated on the Magnetic Recording Medium>

Next, 0.20 g of cationic photopolymerization initiator (product of San-Apro Ltd., trade name: CPI-100P), 0.10 g of 9,10-dibutoxyanthracene as a sensitizer, and 93.2 g of propylene glycol monomethyl ether acetate as a solvent were added to 6.5 g of oxetanyl group-containing silsesquioxane resin (product of Toagosei Co., Ltd., trade name: OX-SQ-H) and the mixture was dispersed in a dark room by using a mix rotor at 60 rpm for 12 hours to prepare an ultraviolet curable resin solution A.

### <UV Nanoimprinting on the Magnetic Recording Medium>

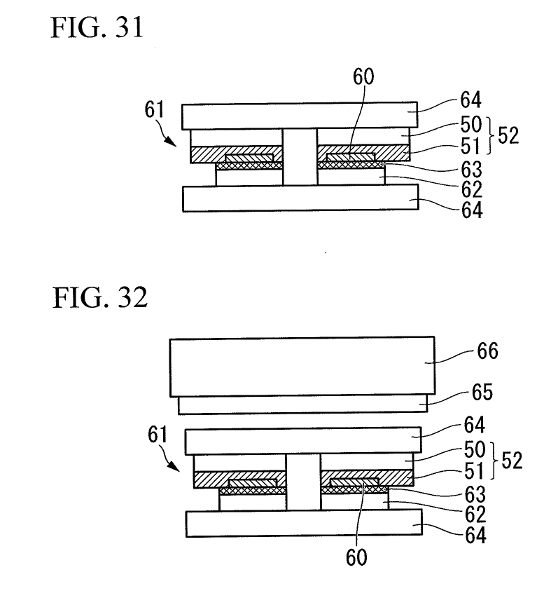

Next, a magnetic recording medium 62 formed by depositing a magnetic layer for perpendicular recording and a protective layer on one side of a disc-like glass substrate having a diameter of 48 mm, a thickness of 0.6 mm, and a central pore with a diameter of 12 mm was prepared. The ultraviolet curable resin solution A prepared as above was then coated on one side of the magnetic recording medium 62 by spin coating to a thickness of about 60 nm. Following the coating step, the replica mold 61 fabricated previously was disposed in a manner in which the pattern portion 60 faces downward as shown in FIG. 31 on the coating film 63 of the ultraviolet curable resin solution A so as to oppose therewith, and these all together were interposed between two synthetic quartz plates 64 (trade name: VIOSIL manufactured by Shin-etsu Chemical Co., Ltd.) so as to be pressurized by self-weight of the synthetic quartz plate.

Subsequently, as shown in FIG. 32, the synthetic quartz plate 64, the replica mold 61, the magnetic recording medium 62, and the synthetic quartz plate 64 were piled up in this order and these were put, as they remain in piles, under an ultraviolet irradiation device 66, wherein a diffusion plate 65 (trade name: Quartz Sol-Gel LSD (UVSP) manufactured by Luminit, LLC (USA)) had been mounted on the underside of an ultraviolet irradiation window of the ultraviolet irradiation device 66, to be irradiated with ultraviolet rays for 30 seconds.

After irradiation, the replica mold 61 was separated from the magnetic recording medium 62. As a result of visually inspecting the pattern film formed on the magnetic recording medium 62, defects such as transfer failure, mold releasing failure, and the like were not confirmed.

### Comparative Example

This comparative example was carried out in the same manner as the above-described example except that in the UV nanoimprint step on the magnetic recording medium, the aforementioned diffusion plate 65 was not mounted onto the ultraviolet irradiation device 66 upon irradiation of the ultraviolet rays. As a result, it was confirmed that upon mold releasing, the pattern film was peeled off from the magnetic recording medium 62 and adhered to the replica mold 61 in 5 places.

### INDUSTRIAL APPLICABILITY

The present invention can provide a pattern forming method which prevents unevenness in the illuminance of the ultraviolet rays irradiated on the substrate and enables to cure the ultraviolet curable resin on the substrate evenly.

1. A pattern forming method comprising:
a first step of forming a first ultraviolet curable resin layer on a substrate;
a second step of leading a pattern-formed surface of a first mold wherein a predetermined pattern is formed to oppose the first ultraviolet curable resin layer, and attaching the substrate to the first mold by applying pressure; and
a third step of irradiating diffused ultraviolet rays on the first ultraviolet curable resin layer, to which the pattern of the first mold is transferred by the pressure-attaching, the irradiated ultraviolet rays being diffused by disposing an ultraviolet light diffusion member between the ultraviolet curable resin layer and an ultraviolet light source.

2. A pattern forming method according to claim 1, wherein the third step is carried out simultaneously with the second step.

3. A pattern forming method according to claim 1, wherein the third step is carried out after the second step.

4. A pattern forming method according to claim 1, further comprises a step of preparing the first mold wherein the predetermined pattern is formed
by forming a second ultraviolet curable resin layer on a resin sheet having a thickness in a range of from 10 μm to 1 mm, and
attaching a second mold having a pattern, wherein protruding portions and recessed portions are inverse to those of the predetermined pattern of the first mold, to the second ultraviolet curable resin layer in a manner in which the pattern having the inverse recessed and protruding portions comes into contact with the surface of the second ultraviolet curable resin layer, by applying a pressure to thereby transfer the pattern having the inverse recessed and protruding portions to the second ultraviolet curable resin layer.

5. A pattern forming method according to claim 1, wherein the first mold has an ultraviolet ray transmittance of 20% or higher.

6. A pattern forming method according to claim 1, wherein the first ultraviolet curable resin layer is formed by coating a liquid ultraviolet curable resin on the substrate.

7. A pattern forming method according to claim 4, wherein the second ultraviolet curable resin layer is formed by coating a liquid ultraviolet curable resin on the resin sheet.

8. A pattern forming method according to claim 1, wherein a diffusion plate or a fly eye lens is used as the ultraviolet light diffusion member.

9. A pattern forming method according to claim 1, wherein the substrate is a magnetic recording medium.

10. A method for fabricating a discrete track magnetic recording medium using a pattern forming method according to claim 1.

11. A magnetic recording/reproducing apparatus equipped with a discrete track magnetic recording medium fabricated by a method according to claim 10.

12. A pattern forming method according to claim 1, wherein the substrate has a structure wherein a magnetic layer and a protective layer are formed in this order on at least one surface of a non-magnetic substrate.

13. A pattern forming method according to claim 1, wherein the ultraviolet light diffusion member is a plate or sheet of materials selected from quartz, glass, and resin, and has a characteristic selected from (i) micro irregularities are formed on the surface; (ii) particles having a refractive index different from that of a matrix is dispersed in the matrix; and (iii) a coating film capable of scattering light is formed on the surface.

14. A pattern forming method according to claim 1, wherein the ultraviolet light diffusion member is the first mold wherein micro irregularities or a coating film capable of scattering light is formed.
